(19) United States
(12) Patent Application Publication
(10) Pub. No.: US 2024/0157498 A1
(43) Pub. Date: May 16, 2024

(54) MANUFACTURING METHOD FOR OPTICAL CONNECTOR

(71) Applicants: Fujikura Ltd., Tokyo (JP); Fujikura Automotive Asia Ltd., Yamagata (JP)

(72) Inventors: Kenichi Ohmori, Sakura-shi (JP); Norihiro Ishikura, Sakura-shi (JP); Ryo Midorikawa, Sakura-shi (JP); Mikhail Illarionov, Sakura-shi (JP); Daisuke Hayasaka, Yonezawa-shi (JP); Atsushi Furugori, Yonezawa-shi (JP)

(73) Assignees: Fujikura Ltd., Tokyo (JP); Fujikura Automotive Asia Ltd., Yamagata (JP)

(21) Appl. No.: 18/283,553

(22) PCT Filed: Feb. 17, 2022
(86) PCT No.: PCT/JP2022/006353

§ 371 Date: Sep. 22, 2023

(30) Foreign Application Priority Data
Mar. 26, 2021 (JP) 2021-053220

(51) Int. Cl. B24B 9/14; G02B 6/38

(52) U.S. Cl. CPC B24B 9/14; G02B 6/3863

(57) ABSTRACT

A manufacturing method for an optical connector includes inserting and fixing a multi-core fiber into a ferrule, wherein at least one of a plurality of cores of the multi-core fiber is a spiral core, inserting the ferrule into a housing and aligning the cores with the housing around a central axis of the multi-core fiber, and obliquely polishing the ferrule until a width of an end surface of the ferrule perpendicular to a direction of the central axis reaches a predefined width.

### BACKGROUND

### Technical Field

The present invention relates to a manufacturing method for an optical connector.

### Description of the Related Art

In recent years, a multi-core fiber in which at least one core among a plurality of cores is spirally formed has been developed. Such a multicore fiber is also called a spun multicore fiber. The spun multicore fiber is used in, for example, contact sensors, shape sensors, and medical applications.

In many cases, an optical connector is provided at a distal end of a spun multicore fiber in which an end surface of the ferrule (end surface of the spun multicore fiber) is obliquely polished by a predetermined angle (for example, 8°) in order to reduce reflection of the end surface. Such an optical connector is also called an angled physical contact (APC) connector. The spun multicore fiber has cores formed in a spiral shape. Therefore, when the end surface of the ferrule is obliquely polished in order to form the APC connector at the distal end of the spun multicore fiber, it is possible that the position of the core may become misaligned resulting in an increase in connection loss.

Patent Document 1 discloses a technology of suppressing such increase in connection loss by reducing the positional misalignment of the core due to oblique polishing. Specifically, in the technology disclosed in Patent Document 1, after the spun multicore fiber is bonded to the ferrule, the ferrule is rotated by an amount that allows compensation for expected positional misalignment of the core due to oblique polishing to provide a rotational offset amount. After the rotational offset amount is provided, the end surface of the ferrule is obliquely polished, thereby reducing the positional misalignment of the core due to oblique polishing.

### Patent Document

Patent Document 1: U.S. Pat. No. 9,366,828

In the technology disclosed in Patent Document 1, if there is no variation in a polished amount when the ferrule is obliquely polished, the positional misalignment of the core can be reduced. However, if there is variation in the polished amount when the ferrule is obliquely polished, a difference between the rotational offset amount expected in advance and the actual amount of positional misalignment of the core due to the oblique polishing becomes large. Thereby, the connection loss may increase.

### SUMMARY

One or more embodiments provide a manufacturing method for an optical connector which can reduce a connection loss over the related art.

A manufacturing method for an optical connector according to one or more embodiments includes: a first step S11 and S41 of inserting and fixing a multi-core fiber 10, in which at least one core among a plurality of cores 12 is spirally formed, into a ferrule 21; a second step S13 and S14 of inserting the ferrule 21 into a housing 22 and performing positional alignment between the plurality of cores and the housing around a central axis of the multi-core fiber; and a third step S15 and S21 of obliquely polishing the ferrule such that (i.e., until) a width 1 of a reference surface PL0, which is an end surface of the ferrule perpendicular to a direction of the central axis of the multi-core fiber, is a predefined width.

In the manufacturing method for an optical connector according to one or more embodiments, the multi-core fiber, in which at least one core among the plurality of cores is spirally formed, is inserted and fixed into the ferrule. Next, the ferrule is inserted into the housing, and a positional alignment between the plurality of cores and the housing is performed around a central axis of the multi-core fiber. Then, the ferrule is obliquely polished such that the width of a reference surface, which is the end surface of the ferrule perpendicular to the direction of the central axis of the multi-core fiber, is the predefined width. As a result, a polished amount can be accurately grasped, and variations when the ferrule is obliquely polished can be suppressed. Therefore, it is possible to reduce connection loss over the related art.

The manufacturing method for an optical connector according to one or more embodiments may further include: a fourth step S12 of polishing the ferrule perpendicularly to the direction of the central axis of the multi-core fiber to form the reference surface, between the first step and the second step.

In the manufacturing method for an optical connector according to one or more embodiments, the second step may be a step of performing positional alignment of the plurality of cores at a position having a rotational offset amount which allows compensation for expected positional misalignment of the core due to oblique polishing of the ferrule.

In the manufacturing method for an optical connector according to one or more embodiments, the third step may be a step of obliquely polishing the ferrule in a state where the housing is rotated around the central axis of the multi-core fiber to have a rotational offset amount, which allows compensation for expected positional misalignment of the core due to oblique polishing of the ferrule.

The manufacturing method for an optical connector according to one or more embodiments may further include: a fifth step S16 of rotating the ferrule around the central axis of the multi-core fiber by a certain angle to fix the ferrule to the housing, after the third step.

Alternatively, the manufacturing method for an optical connector according to one or more embodiments may further include: a sixth step S43 of aligning positions of the plurality of cores to fix the ferrule to the housing, after the third step.

The manufacturing method for an optical connector according to one or more embodiments, when the rotational offset amount is defined as φ, the rotational offset amount φ may be expressed by the following Equation by using a spiral period fw of the multi-core fiber, a diameter d of the reference surface before oblique polishing, a width 1 of the reference surface, and an angle θ_{APC} at which the ferrule is obliquely polished.

$$φ = \frac{2 π}{fw} \times ( \frac{d}{2} - l ) \times tan {θ}_{APC} \qquad Equation 1$$

In the manufacturing method for an optical connector according to one or more embodiments, the first step may be a step of fixing the multi-core fiber to the ferrule such that, in a state where positions of the plurality of cores around the central axis of the multi-core fiber having a polished end surface are aligned with respect to the ferrule, the end surface is flush with the end surface of the ferrule.

According to one or more embodiments, it is possible to reduce a connection loss over the related art.

### BRIEF DESCRIPTION OF THE DRAWINGS

FIG. 1 is a perspective view showing a main configuration of an optical connector according to a first example.

FIG. 2A is an enlarged view showing a tip portion of a ferrule included in the optical connector according to the first example.

FIG. 2B is an enlarged view showing the tip portion of the ferrule included in the optical connector according to the first example.

FIG. 3 is a flowchart showing a manufacturing method for an optical connector according to the first example.

FIG. 4A is a view explaining the manufacturing method for an optical connector according to the first example.

FIG. 4B is a view explaining the manufacturing method for an optical connector according to the first example.

FIG. 4C is a view explaining the manufacturing method for an optical connector according to the first example.

FIG. 5A is a view explaining the manufacturing method for an optical connector according to the first example.

FIG. 5B is a view explaining the manufacturing method for an optical connector according to the first example.

FIG. 6 is a view explaining the manufacturing method for an optical connector according to the first example.

FIG. 7A is a view explaining the manufacturing method for an optical connector according to the first example.

FIG. 7B is a view explaining the manufacturing method for an optical connector according to the first example.

FIG. 8 is a diagram showing a relationship between a width of a reference surface obtained by simulation and a connection loss.

FIG. 9 is a flowchart showing a manufacturing method for an optical connector according to a second example.

FIG. 10A is a view explaining the manufacturing method for an optical connector according to the second example.

FIG. 10B is a view explaining the manufacturing method for an optical connector according to the second example.

FIG. 11 is a flowchart showing a manufacturing method for an optical connector according to a third example.

FIG. 12A is a view explaining the manufacturing method for an optical connector according to the third example.

FIG. 12B is a view explaining the manufacturing method for an optical connector according to the third example.

FIG. 13 is a flowchart showing a manufacturing method for an optical connector according to a fourth example.

FIG. 14 is a flowchart showing a manufacturing method for an optical connector according to a fifth example.

FIG. 15 is an enlarged view showing a tip portion of a ferrule included in a so-called conical-type optical connector.

### DESCRIPTION OF THE EMBODIMENTS

Hereinafter, a manufacturing method for an optical connector according to embodiments will be described in detail with reference to the drawings. In the drawings to be referred to below, for the sake of easy understanding, the scale of dimension of each member may be appropriately changed if necessary.

### First Example

### <Optical Connector and Multi-Core Fiber>

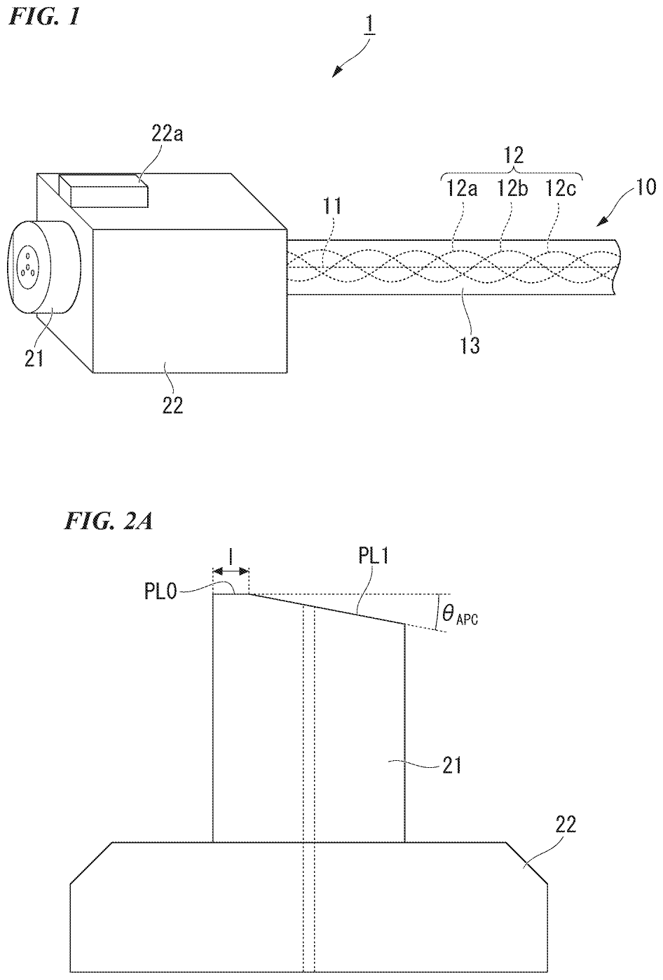

FIG. 1 is a perspective view showing a main configuration of an optical connector according to a first example. As shown in FIG. 1, an optical connector 1 according to one or more embodiments is provided at an end portion of a multi-core fiber 10, and the multi-core fiber 10 is connected to other multi-core fibers or devices (not shown). For the sake of easy understanding, FIG. 1 shows the multi-core fiber 10 in a perspective view.

The multi-core fiber 10 includes a central core 11, an outer peripheral core 12 (outer peripheral cores 12a to 12c), and a cladding 13. An outer peripheral surface of the cladding 13 may be covered with a coating (not shown). The central core 11 may be a core formed in the center of the multi-core fiber 10 in parallel to a central axis of the multi-core fiber 10. The central core 11 forms an optical path linear with respect to a longitudinal direction of the multi-core fiber 10 in the center of the multi-core fiber 10.

The central core 11 may be formed of, for example, silica glass containing germanium (Ge). In addition, in the central core 11, fiber bragg grating (FBG) may be formed over the entire length thereof. The diameter of the central core 11 is set in a range of, for example, about 5 to 7 [μm].

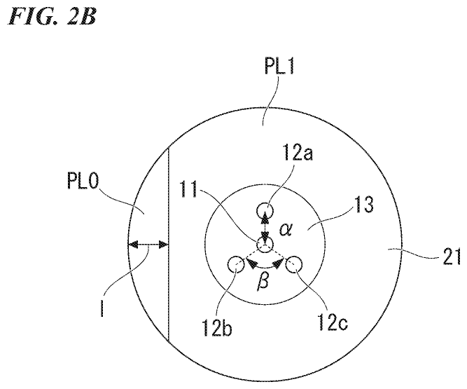

The outer peripheral core 12 is a core formed to spirally surround the periphery of the central core 11. Specifically, the outer peripheral core 12 includes three outer peripheral cores 12a to 12c which are spaced apart from the central core 11 by a predetermined distance α (see FIG. 2B), and which are disposed at an interval of an angle β (for example, 120°) in a cross section orthogonal to the longitudinal direction. These outer peripheral cores 12a to 12c extend in the longitudinal direction of the multi-core fiber to spirally surround the periphery of the central core 11 while maintaining an interval of an angle θ from each other. These outer peripheral cores 12a to 12c form three spiral optical paths surrounding the central core 11 in the multi-core fiber 10.

The outer peripheral cores 12a to 12c may be formed of, for example, silica glass containing germanium (Ge), similarly to the central core 11. In addition, the outer peripheral cores 12a to 12c may have FBG formed over the entire length thereof. The outer peripheral cores 12a to 12c have the same diameter (or substantially the same diameter) as the central core 11, and are set in a range of, for example, about 5 to 7 [μm]. The outer peripheral cores 12a to 12c may have different diameters from the central core 11.

The distance α between the central core 11 and the outer peripheral cores 12a to 12c is set in consideration of a crosstalk between the cores, a difference in optical path length between the central core 11 and the outer peripheral cores 12a to 12c, a difference in strain amount between the central core 11 and the outer peripheral cores 12a to 12c when the multi-core fiber 10 is bent. The distance α between the central core 11 and the outer peripheral cores 12a to 12c is set to, for example, about 35 [μm]. The number of spirals of the outer peripheral cores 12a to 12c per unit length is set to, for example, about 50 [turns/m]. In other words, the length of one period of the outer peripheral cores 12a to 12c (to be precise, the length of the multi-core fiber 10 in the longitudinal direction per one turn of the outer peripheral cores 12a to 12c: spiral period) is set to about 20 [mm].

The cladding 13 is a common cladding which covers the periphery of the central core 11 and the outer peripheral cores 12a to 12c and whose outer circumference shape is a cylindrical shape. Since the central core 11 and the outer peripheral cores 12a to 12c are covered with the common cladding 13, it can be said that the central core 11 and the outer peripheral cores 12a to 12c are formed inside the cladding 13. The cladding 13 may be formed of, for example, silica glass.

The optical connector 1 includes a ferrule 21 and a housing 22. The ferrule 21 is an annular column-shaped member in which fiber holes into which the multi-core fiber is inserted are formed. The housing 22 is a substantially rectangular parallelepiped member that houses the ferrule 21. The housing 22 is also called a plug frame. The housing 22 is formed with a key 22a that is used for positional alignment with other multi-core fibers or the like while preventing erroneous connection to other multi-core fibers or the like to be connected. The positions of the outer peripheral cores 12a to 12c on the end surface of the multi-core fiber 10 are aligned with reference to the key 22a formed in the housing 22.

The ferrule 21 is fixed to the end portion of the multi-core fiber 10 such that one end side of the ferrule 21 is flush with (or substantially flush with) the end surface of the multi-core fiber 10 and is integrated with the multi-core fiber 10. The ferrule 21 is movable along the direction of the central axis of the multi-core fiber 10, but is housed in the housing 22 not to rotate around the central axis of the multi-core fiber 10. Therefore, the multi-core fiber 10, which is fixed to be integrated with the ferrule 21, does not rotate around the central axis of the multi-core fiber 10 as well.

FIGS. 2A and 2B are enlarged views showing a tip portion of the ferrule included in the optical connector according to the first example, in which FIG. 2A is a side view of the tip portion of the ferrule and FIG. 2B is a front view of the tip portion of the ferrule. As shown in FIG. 2A, the optical connector 1 of one or more embodiments is an angled physical contact (APC) connector in which the end surface of the ferrule 21, into which the multi-core fiber 10 is inserted, is obliquely polished by a predetermined angle θ_{APC}. It should be noted that θ_{APC} is, for example, 8°. The optical connector 1 is a so-called straight-type connector in which the diameter of the tip portion of the ferrule 21 is constant.

As shown in FIGS. 2A and 2B, the tip portion of the ferrule 21 is formed with a reference surface PL0, which is an end surface perpendicular to the direction of the central axis of the multi-core fiber 10 and an inclined surface PL1 forming the angle θ_{APC} with respect to the reference surface PL0. Although descriptions thereof will be made in more detail, the inclined surface PL1 is formed such that a width 1 of the reference surface PL0 is a predefined width. Accordingly, variation in a polished amount when the ferrule 21 is obliquely polished to form the inclined surface PL1 is suppressed, thereby reducing a connection loss compared with the related art.

In this case, the reference surface PL0 has a substantially “D” shape as shown in FIG. 2B. That is, the reference surface PL0 has a shape including a straight line (an intersection line between the reference surface PL0 and the inclined surface PL1) and a curved line (an outer edge of the ferrule 21). The width 1 of the reference surface PL0 is an arrow height (height of the arc) when the straight line is regarded as a chord and the curved line is regarded as an arc.

### <Manufacturing Method for Optical Connector>

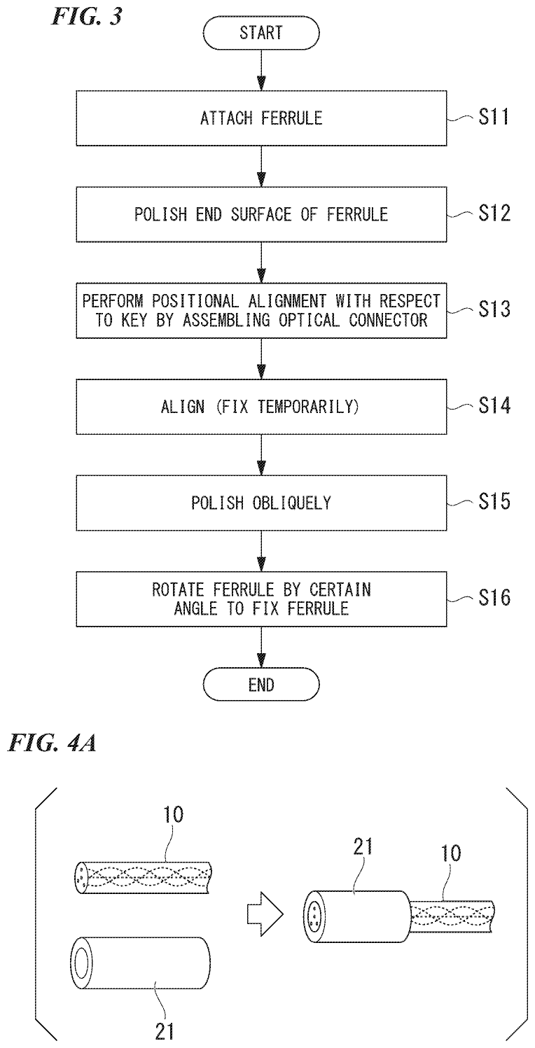

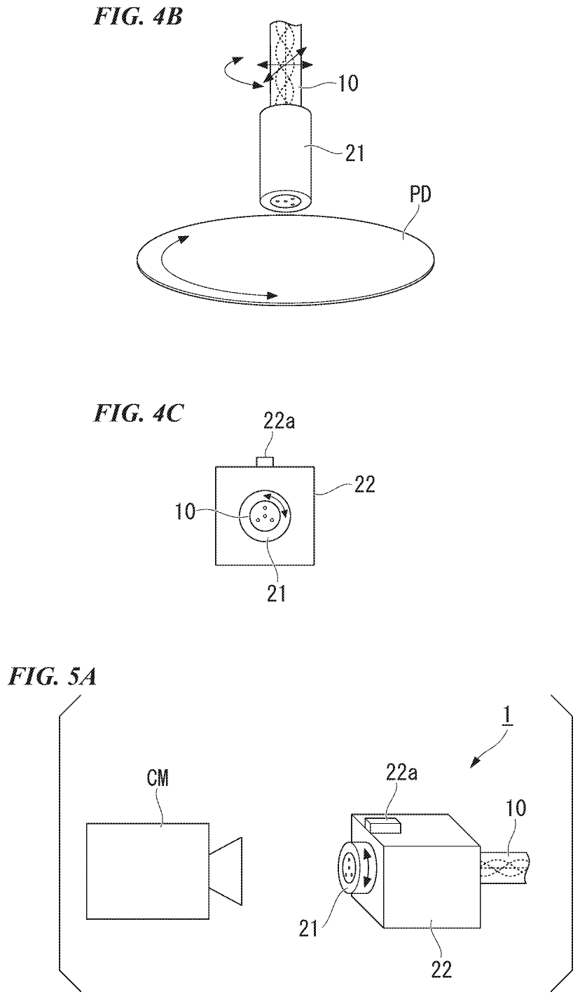

FIG. 3 is a flowchart showing a manufacturing method for an optical connector according to the first example. In addition, FIGS. 4A to 7B are views explaining the manufacturing method for an optical connector according to the first example. As shown in FIG. 3, first, a step of attaching the multi-core fiber 10 to the ferrule 21 is performed (step S11: first step). Specifically, as shown in FIG. 4A, a step of fixing the ferrule 21 to the end portion of the multi-core fiber 10 by preparing the multi-core fiber 10 and the ferrule 21 is performed. For example, an adhesive is used to fix the ferrule 21 to the multi-core fiber 10.

Next, a step of polishing the end surface of the ferrule 21 fixed with the multi-core fiber 10 is performed (step S12: fourth step). Specifically, as shown in FIG. 4B, a step of polishing the end surface (one end side of the ferrule 21) of the multi-core fiber 10 by bringing the end surface of the multi-core fiber 10 into contact with the polishing surface is performed such that the central axis of the multi-core fiber 10 is perpendicular to the polishing surface of a polishing device PD. The polishing in this step is, for example, flat polishing. The step is performed so that a surface (reference surface PL0) perpendicular to the direction of the central axis of the multi-core fiber 10 is formed in the ferrule 21. The end surface of the multi-core fiber 10 may be polished one by one, or a plurality of end surfaces of the multi-core fiber 10 may be polished at the same time. The plurality of end surfaces of the multi-core fiber 10 are polished at the same time, so that it is efficient because a time can be shortened.

Next, a step of aligning positions of the outer peripheral cores 12a to 12c with respect to the key 22a by assembling the optical connector 1 is performed (step S13: second step). Specifically, first, a step of assembling the optical connector 1 by housing the ferrule 21 to the housing 22 such that the ferrule 21 is rotatable around the central axis of the multi-core fiber 10. Then, as shown in FIG. 4C, a step of integrally rotating the multi-core fiber 10 and the ferrule 21 around the central axis of the multi-core fiber 10 to roughly align the positions of the outer peripheral cores 12a to 12c on the end surface of the multi-core fiber 10 with reference to the key 22a formed in the housing 22, is performed.

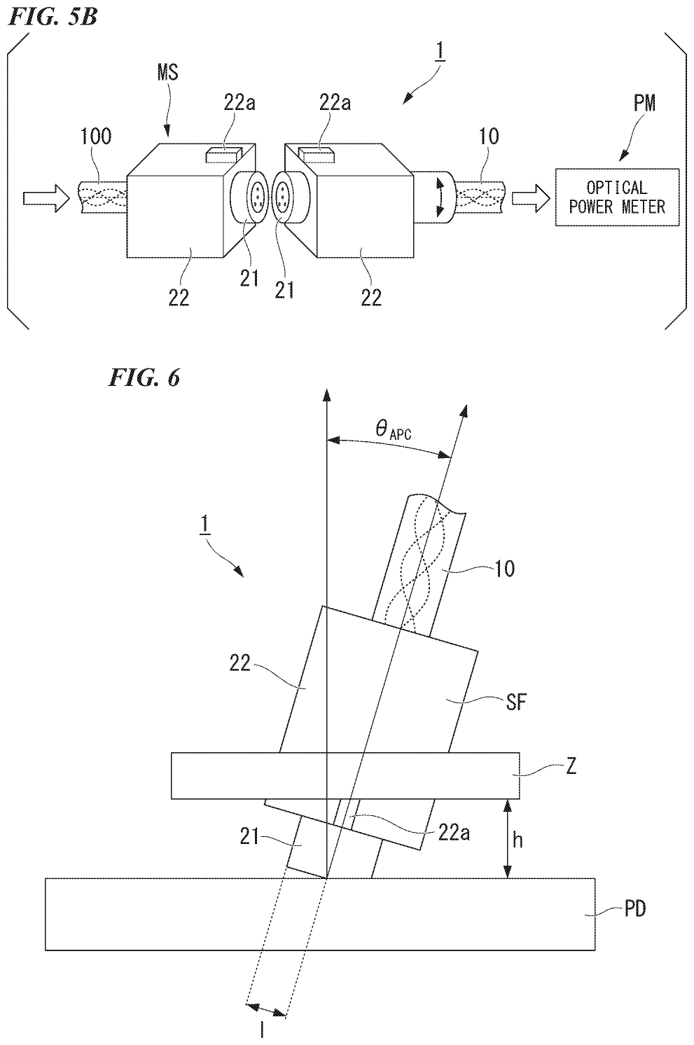

Subsequently, a step of aligning the positions of the outer peripheral cores 12a to 12c on the end surface of the multi-core fiber 10 to temporarily fix the multi-core fiber 10 (ferrule 21) to the housing 22 is performed (step S14: second step). In the present specification, the term “temporarily fix” means simply fixing (for example, fixing with a jig) and fixing the multicore fiber 10 in order to prevent misalignment during polishing. For example, as shown in FIG. 5A, aligning is performed by rotating the multi-core fiber together with the ferrule 21 using a camera CM or a microscope (not shown), while viewing images of the end surface of the multi-core fiber 10 and the key 22a of the housing 22, which are captured by the camera CM or the like.

Alternatively, as shown in FIG. 5B, a multi-core fiber 100, to which an optical connector MS serving as a master is attached, and an optical power meter PM are used for aligning. Specifically, the multi-core fiber 100 and the multi-core fiber 10 are connected by performing accurate positional alignment between the key 22a of the optical connector MS and the key 22a of the optical connector 1, using an adapter (not shown) or the like. Then, aligning is performed by monitoring power of light, which propagates from the multi-core fiber 100 to the multi-core fiber 10, with an optical power meter PM while rotating the multi-core fiber 10 together with the ferrule 21.

In the aligning method shown in FIG. 5B, the total power of light, which propagates through each core, may be monitored using one optical power meter PM, or power of light, which propagates through each core, may be individually monitored using a plurality of optical power meters PM. Alternatively, an optical switch may be used to switch cores through which light is propagated, and the power of light propagating through each core may be sequentially monitored. The cores through which light is propagated may be limited to specific one or two cores, and only the power of light propagating through these limited cores may be monitored.

Subsequently, a step of obliquely polishing the end surface of the ferrule 21 is performed (step S15: third step). Specifically, as shown in FIG. 6, a step of attaching the optical connector 1 to a jig Z such that the central axis of the multi-core fiber 10 is inclined and polishing the end surface of the ferrule 21 (multi-core fiber 10) by bringing the ferrule 21 (multi-core fiber 10) into contact with the polishing surface of the polishing device PD, is performed.

In this case, the optical connector 1 is attached to the jig Z such that the central axis of the multi-core fiber 10 forms a predetermined angle θ_{APC} (for example, 8°) with respect to a perpendicular line of the polishing surface of the polishing device PD. In addition, an orientation of the optical connector 1 is set with reference to the key 22a formed in the housing 22. Specifically, one surface SF of the housing 22 in which the key 22a is formed is set to be parallel to a surface including the central axis of the multi-core fiber 10 and the perpendicular line of the polishing surface of the polishing device PD.

The oblique polishing of the ferrule 21 is performed such that the width 1 of the reference surface PL0 of the ferrule 21 (surface formed in step S12) (see FIGS. 2A and 2B) is a predefined width. Accordingly, variation in a polished amount when the end surface of the ferrule 21 is obliquely polished to form the inclined surface PL1 is suppressed, thereby reducing a connection loss compared with the related art. For example, as shown in FIG. 6, the polished amount of the ferrule 21 is adjusted such that the width 1 of the reference surface PL0 is the width while referring to a height position of the jig Z with respect to the polishing surface of the polishing device PD and a polishing time.

Finally, a step of fixing the ferrule 21 to the housing 22 is performed after rotating the ferrule 21 around the central axis of the multi-core fiber 10 by a certain angle (step S16: fifth step). The certain angle is an angle that can minimize the positional misalignment of the outer peripheral cores 12a to 12c caused by the oblique polishing of the ferrule 21 performed in step S15. The angle is obtained in advance from the width 1 of the reference surface PL0, the angle θ_{APC} of the inclined surface PL1, and structural parameters (the distance α between the central core 11 and the outer peripheral core 12 and the spiral period, and the like) of the multi-core fiber 10.

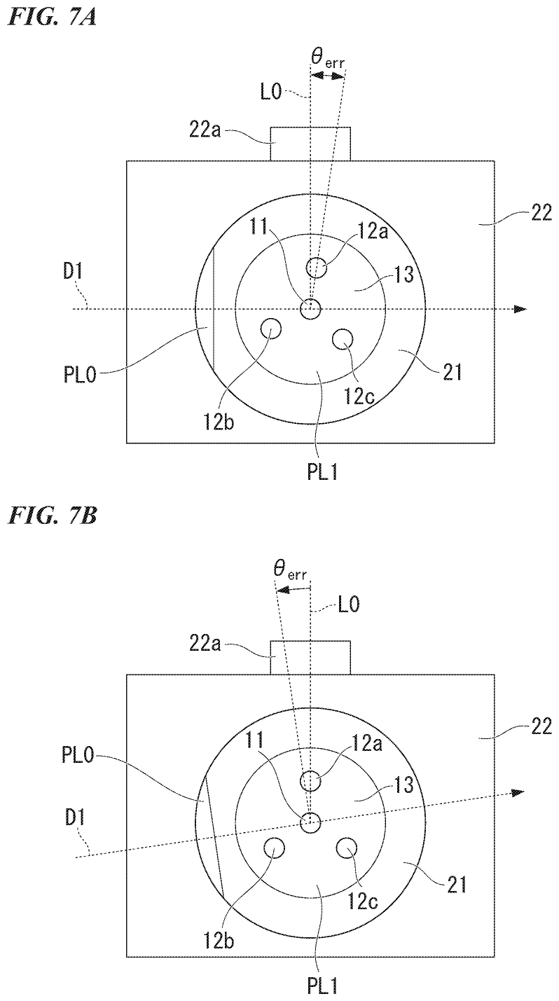

For example, it is assumed that an angle of the positional misalignment of the outer peripheral cores 12a to 12c with respect to the key 22a, which is caused by the oblique polishing of the ferrule 21 performed in step S15, is defined as θₑᵣᵣ, as shown in FIG. 7A. Then, in step S16, as shown in FIG. 7B, a step of fixing the ferrule 21 to the housing 22 by rotating the ferrule 21 and the multi-core fiber 10 counterclockwise by the angle θ, is performed. The optical connector 1 is manufactured by the above steps.

In this case, as shown in FIG. 7A, when the ferrule 21 is obliquely polished (when step S15 ends), an inclination direction D1 of the inclined surface PL1 is perpendicular to a straight line L0 passing through the central core 11 and the key 22a. In step S16, when the ferrule 21 and the multi-core fiber 10 are rotated counterclockwise by the angle θₑᵣᵣ, the inclination direction D1 of the inclined surface PL1 is no longer perpendicular to the straight line L0 passing through the central core 11 and the key 22a. That is, in the optical connector 1 manufactured in one or more embodiments, no positional misalignment of the outer peripheral cores 12a to 12c occurs with respect to the key 22a, but the inclined surface PL1 is rotated by an angle θₑᵣᵣ with respect to the key 22a.

The ferrule 21 is movable in a direction of the central axis of the multi-core fiber 10, but is fixed to the housing 22 not to rotate around the central axis of the multi-core fiber 10. The multi-core fiber 10 is fixed to be integrated with the ferrule 21. Therefore, the multi-core fiber 10 is also movable along the central axis of the multi-core fiber 10, but is not rotated around the central axis of the multi-core fiber 10.

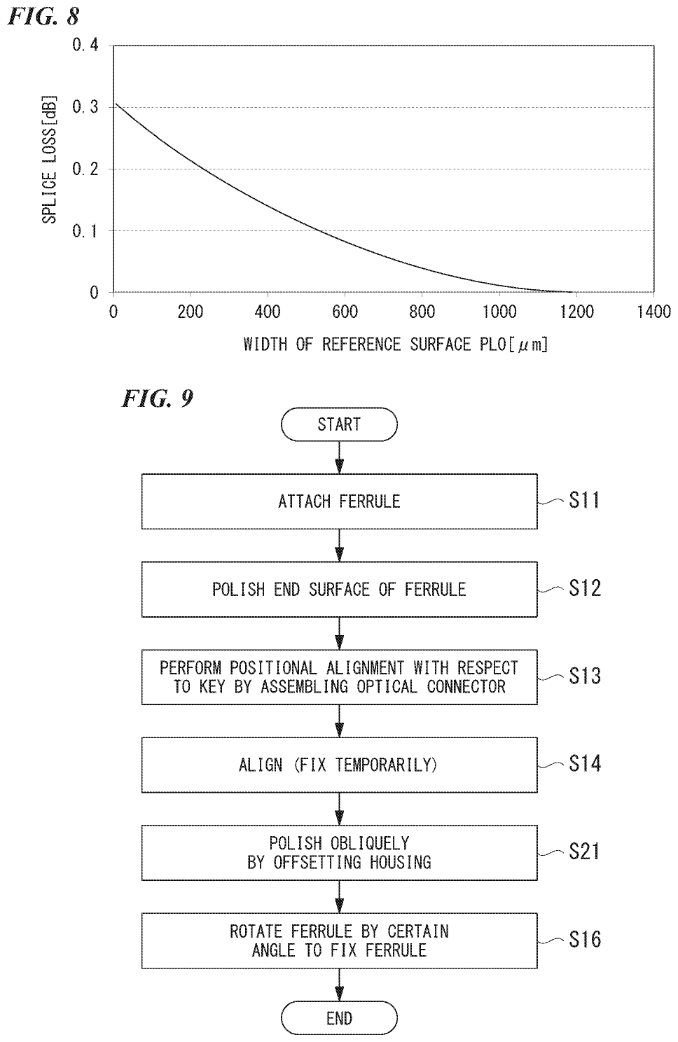

FIG. 8 is a diagram showing a relationship between a width of a reference surface obtained by simulation and a connection loss. In the graph shown in FIG. 8, a vertical axis represents a width 1 of the reference surface PL0, and a horizontal axis represents a connection loss. With reference to FIG. 8, it can be seen that the connection loss increases as the width 1 of the reference surface PL0 decreases. However, when the ferrule 21 is obliquely polished such that the reference surface PL0 remains even slightly (when the width 1 of the reference surface PL0 is not zero), the connection loss, which is caused by the positional misalignment of the outer peripheral cores 12a to 12c due to oblique polishing, is 0.3 [dB] or less, and it is thus possible to realize a connection loss without any issue in practical use.

As described above, in one or more embodiments, first, the multi-core fiber 10, in which the central core 11 and the spiral outer peripheral core 12 are formed, is inserted into and fixed to the ferrule 21. Next, the ferrule 21 is inserted into the housing 22 to align the position of the outer peripheral core 12 around the central axis of the multi-core fiber 10. Then, the ferrule 21 is obliquely polished such that the width 1 of the reference surface PL0 of the ferrule 21 is the predefined width. As a result, since the polished amount can be accurately grasped and variations when the ferrule 21 is obliquely polished can be suppressed, the connection loss can be reduced over the related art.

### Second Example

### <Optical Connector>

An optical connector 2 according to one or more embodiments is configured in the same manner as the optical connector 1 shown in FIG. 1, except for the inclination direction D1 of the inclined surface PL1 of the ferrule 21. Therefore, the detailed description of the optical connector 2 will be omitted.

### <Manufacturing Method for Optical Connector>

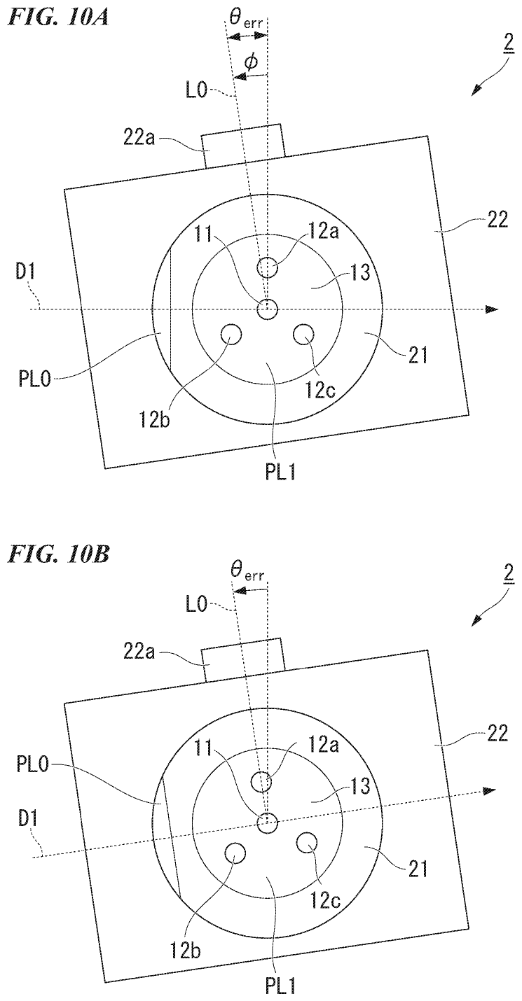

FIG. 9 is a flowchart showing a manufacturing method for an optical connector according to a second example. In addition, FIGS. 10A and 10B are views explaining the manufacturing method for an optical connector according to the second example. In FIG. 9, the same reference numerals are given to the same steps as those shown in FIG. 3. In the flowchart shown in FIG. 9, step S15 of the flowchart shown in FIG. 3 is replaced with step S21.

In one or more embodiments, as in the first example, first, a step of attaching the multi-core fiber 10 to the ferrule 21 (step S11), and a step of polishing the end surface of the ferrule 21 fixed with the multi-core fiber 10 (step S12), are performed. Next, a step of aligning positions of the outer peripheral cores 12a to 12c with respect to the key 22a by assembling the optical connector 2 is performed (step S13). Then, a step of aligning the positions of the outer peripheral cores 12a to 12c on the end surface of the multi-core fiber 10 to temporarily fix the multi-core fiber 10 (ferrule 21) to the housing 22 is performed (step S14).

Subsequently, in one or more embodiments, a step of obliquely polishing the end surface of the ferrule 21 by offsetting the housing 22 is performed (step S21: third step). Specifically, as shown in FIG. 10A, the optical connector 2 is attached to the jig Z (see FIG. 6) such that the housing 22 is rotated around the central axis of the multi-core fiber by a rotational offset amount (p. Then, a step of polishing the end surface of the ferrule 21 (multi-core fiber 10) by bringing the ferrule 21 (multi-core fiber 10) into contact with the polishing surface of the polishing device PD, is performed.

In this case, the rotational offset amount φ is an amount that can compensate for the positional misalignment of the outer peripheral cores 12a to 12c, which is expected due to the oblique polishing of the ferrule 21. When a spiral period of the multi-core fiber 10 is defined as fw, the diameter of the reference surface PL0 (diameter before oblique polishing) is defined as d, the width of the reference surface PL0 is defined as l, and the angle of oblique polishing of the ferrule 21 is defined as θ_{APC}, the rotational offset amount φ is expressed by the following Equation (1).

$$Equation 1$$

$$φ = \frac{2 π}{fw} \times ( \frac{d}{2} - l ) \times tan {θ}_{APC} \qquad ( 1 )$$

The oblique polishing of the ferrule 21 is performed in the same manner as in the first example except that the housing 22 is offset. That is, the oblique polishing of the ferrule 21 is performed such that the width 1 of the reference surface PL0 of the ferrule 21 (surface formed in step S12) is the predefined width.

Finally, a step of fixing the ferrule 21 to the housing 22 is performed after rotating the ferrule 21 around the central axis of the multi-core fiber 10 by a certain angle (step S16). The step is performed in the same manner as in the first example. For example, it is assumed that an angle of the positional misalignment of the outer peripheral cores 12a to 12c with respect to the key 22a, which is caused by the oblique polishing of the ferrule 21, is defined as θₑᵣᵣ, as shown in FIG. 10A. Then, in step S16, as shown in FIG. 10B, a step of fixing the ferrule 21 to the housing 22 by rotating the ferrule 21 and the multi-core fiber 10 counterclockwise by the angle θₑᵣᵣ is performed. The optical connector 2 is manufactured by the above steps.

In this case, in one or more embodiments, the ferrule 21 is obliquely polished in a state where the housing 22 is offset. Therefore, as shown in FIG. 10A, when the ferrule 21 is obliquely polished (when step S21 ends), an inclination direction D1 of the inclined surface PL1 is not perpendicular to a straight line L0 passing through the central core 11 and the key 22a. In step S16, when the ferrule 21 and the multi-core fiber 10 are rotated counterclockwise by the angle θₑᵣᵣ, the inclination direction D1 of the inclined surface PL1 is perpendicular to the straight line L0 passing through the central core 11 and the key 22a as shown in FIG. 10B. That is, in the optical connector 2 manufactured in one or more embodiments, no positional misalignment of the outer peripheral cores 12a to 12c occurs with respect to the key 22a, and the angle of the inclined surface PL1 with respect to the key 22a is aligned.

The ferrule 21 is movable in a direction of the central axis of the multi-core fiber 10, but is fixed to the housing 22 not to rotate around the central axis of the multi-core fiber 10. Since the multi-core fiber 10 is fixed to be integrated with the ferrule 21, the multi-core fiber 10 is also movable along the central axis of the multi-core fiber 10, but is not rotated around the central axis of the multi-core fiber 10.

As described above, in one or more embodiments, first, the multi-core fiber 10, in which the central core 11 and the spiral outer peripheral core 12 are formed, is inserted into and fixed to the ferrule 21. Next, the ferrule 21 is inserted into the housing 22 to align the position of the outer peripheral core 12 around the central axis of the multi-core fiber 10. In a state the housing 22 is rotated by the rotational offset amount φ around the central axis of the multi-core fiber 10, the ferrule 21 is obliquely polished such that the width 1 of the reference surface PL0 of the ferrule 21 is the predefined width. As a result, a polished amount can be accurately grasped, and variations when the ferrule 21 is obliquely polished can be suppressed. Accordingly, the connection loss can be reduced as compared with the related art.

Further, in one or more embodiments, the ferrule 21 is obliquely polished in a state where the housing 22 is rotated around the central axis of the multi-core fiber 10 by the rotational offset amount gyp, and after the oblique polishing, the ferrule 21 and the multi-core fiber 10 are rotated by a certain angle. Therefore, the position of the outer peripheral core 12 with respect to the key 22a and the angle of the inclined surface PL1 with respect to the key 22a can be aligned.

### Third Example

### <Optical Connector>

As in the second example, an optical connector 3 according to one or more embodiments is configured in the same manner as the optical connector 1 shown in FIG. 1, except for the inclination direction D1 of the inclined surface PL1 of the ferrule 21. Therefore, a detailed description of the optical connector 3 will be omitted.

### <Manufacturing Method for Optical Connector>

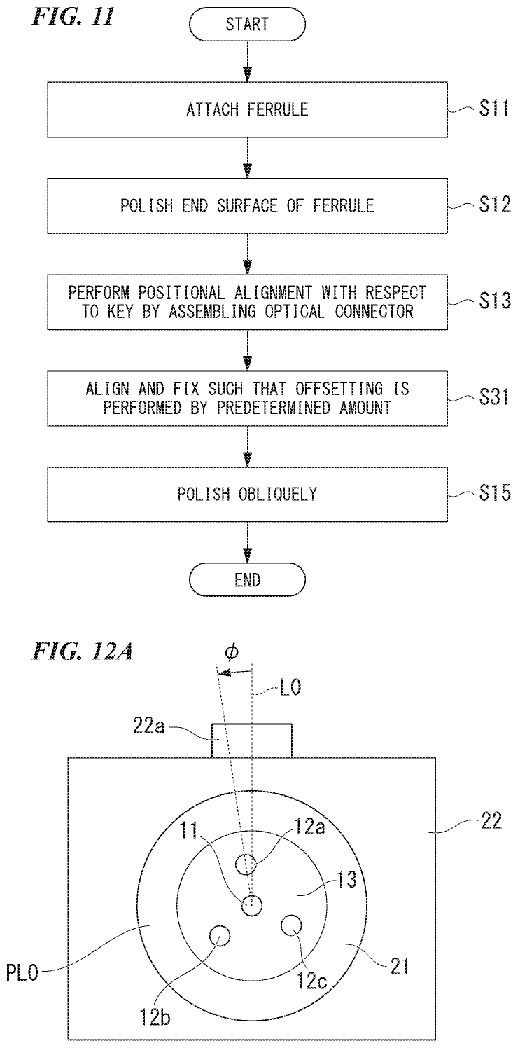

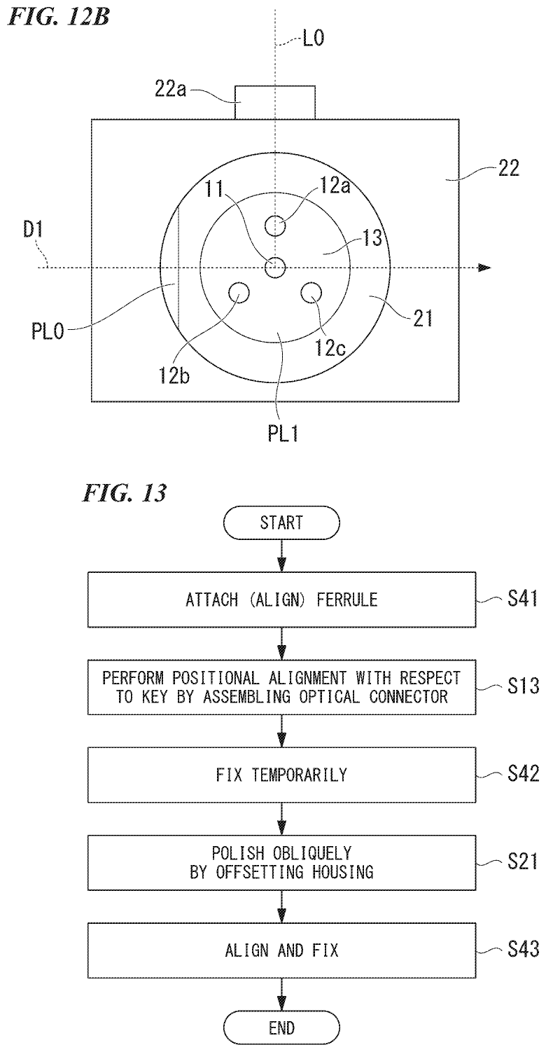

FIG. 11 is a flowchart showing a manufacturing method for an optical connector according to a third example. In addition, FIGS. 12A and 12B are views explaining the manufacturing method for an optical connector according to the third example. In FIG. 11, the same reference numerals are given to the same steps as those shown in FIG. 3. In the flowchart shown in FIG. 11, step S14 of the flowchart shown in FIG. 3 is replaced with step S31, and step S16 is omitted.

In one or more embodiments, as in the first example, first, a step of attaching the multi-core fiber 10 to the ferrule 21 (step S11), and a step of polishing the end surface of the ferrule 21 fixed with the multi-core fiber 10 (step S12), are performed. Next, a step of aligning positions of the outer peripheral cores 12a to 12c with respect to the key 22a by assembling the optical connector 3 is performed (step S13).

Subsequently, in one or more embodiments, a step of fixing the ferrule 21 (multi-core fiber 10) to the housing 22 by aligning the positions of the outer peripheral cores 12a to 12c on the end surface of the multi-core fiber 10 to offset by a predetermined amount, is performed (step S31). Specifically, as shown in FIG. 12A, a step of aligning the outer peripheral cores 12a to 12c of the multi-core fiber 10 such that the outer peripheral cores 12a to 12c of the multi-core fiber 10 is rotated by a rotational offset amount φ around the central axis of the multi-core fiber 10, is performed.

In this case, the rotational offset amount φ is an amount that can compensate for the positional misalignment of the outer peripheral cores 12a to 12c, which is expected due to the oblique polishing of the ferrule 21 and is the same as the rotational offset amount φ in the second example. The rotational offset amount φ is expressed by Equation (1) described above.

The ferrule 21 is movable in a direction of the central axis of the multi-core fiber 10, but is fixed to the housing 22 not to rotate around the central axis of the multi-core fiber 10. Since the multi-core fiber 10 is fixed to be integrated with the ferrule 21, the multi-core fiber 10 is also movable along the central axis of the multi-core fiber 10 but is not rotated around the central axis of the multi-core fiber 10.

Finally, a step of obliquely polishing the end surface of the ferrule 21 is performed (step S15). Specifically, as in the first example, the optical connector 3 is attached to the jig Z such that the central axis of the multi-core fiber 10 is inclined (see FIG. 6). Then, a step of polishing the end surface of the ferrule 21 (multi-core fiber 10) by bringing the ferrule 21 (multi-core fiber 10) into contact with the polishing surface of the polishing device PD, is performed. The optical connector 3 is manufactured by the above steps.

When the ferrule 21 is obliquely polished, the positional misalignment (rotational offset amount φ) of the outer peripheral cores 12a to 12c with respect to the key 22a is eliminated as shown in FIG. 12B, so that no positional misalignment occurs with respect to the key 22a. In addition, the inclination direction D1 of the inclined surface PL1 is perpendicular to the straight line L0 passing through the central core 11 and the key 22a. That is, in the optical connector 3 manufactured in one or more embodiments, as in the optical connector 2 manufactured in the second example, no positional misalignment of the outer peripheral cores 12a to 12c occurs with respect to the key 22a, and the angle of the inclined surface PL1 with respect to the key 22a is aligned.

As described above, in one or more embodiments, first, the multi-core fiber 10, in which the central core 11 and the spiral outer peripheral core 12 are formed, is inserted into and fixed to the ferrule 21. Next, the ferrule 21 is inserted into the housing 22 to perform positional alignment of the outer peripheral core 12 at a position having the rotational offset amount φ that can eliminate the positional misalignment of the outer peripheral core 12, which occurs due to oblique polishing. Then, the ferrule 21 is obliquely polished such that the width 1 of the reference surface PL0 of the ferrule 21 is the predefined width. As a result, since the polished amount can be accurately grasped and variations when the ferrule 21 is obliquely polished can be suppressed, the connection loss can be reduced over the related art.

Further, in one or more embodiments, the ferrule 21 is obliquely polished in a state where the positional alignment of the outer peripheral core 12 is performed at a position having the rotational offset amount φ that can eliminate the positional misalignment of the outer peripheral core 12, which occurs due to oblique polishing. Therefore, the position of the outer peripheral core 12 with respect to the key 22a and the angle of the inclined surface PL1 with respect to the key 22a can be aligned.

### Fourth Example

### <Optical Connector>

As in the second example, an optical connector 4 according to one or more embodiments is configured in the same manner as the optical connector 1 shown in FIG. 1, except for the inclination direction D1 of the inclined surface PL1 of the ferrule 21. Therefore, a detailed description of the optical connector 4 will be omitted.

### <Manufacturing Method for Optical Connector>

FIG. 13 is a flowchart showing a manufacturing method for an optical connector according to a fourth example. In FIG. 13, the same reference numerals are given to the same steps as those shown in FIGS. 3 and 9. In the flowchart shown in FIG. 13, steps S11, S14, and S16 in the flowchart shown in FIG. 3 are each replaced with steps S41, S42, and S43, step S12 is omitted, and step S15 is replaced with step S21 shown in FIG. 9.

In one or more embodiments, first, a step of aligning the multi-core fiber 10 by attaching the multi-core fiber 10, which has a polished end surface, to the ferrule 21 such that the end surface of the multi-core fiber 10 is flush with the end surface of the ferrule 21, is performed (step S41: first step). Specifically, a step, in which the multi-core fiber is inserted into the ferrule 21, the multi-core fiber 10 is aligned with respect to the ferrule 21, and then the ferrule 21 is fixed to the end portion of the multi-core fiber 10, is performed. For example, an adhesive is used to fix the ferrule 21 to the multi-core fiber 10.

Next, as in the first example, a step of aligning positions of the outer peripheral cores 12a to 12c with respect to the key 22a by assembling the optical connector 4 is performed (step S13). Then, a step of temporarily fixing the multi-core fiber 10 (ferrule 21) to the housing 22 is performed (step S42).

Subsequently, in one or more embodiments, as in the second example, a step of obliquely polishing the end surface of the ferrule 21 by offsetting the housing 22 is performed (step S21). Finally, a step of aligning the positions of the outer peripheral cores 12a to 12c on the end surface of the multi-core fiber 10 to fix the multi-core fiber 10 (ferrule 21) to the housing 22 is performed (step S43: sixth step). The positions of the outer peripheral cores 12a to 12c can be aligned by the method described with reference to FIGS. 5A and 5B, for example. The optical connector 4 is manufactured by the above steps.

The ferrule 21 is movable in a direction of the central axis of the multi-core fiber 10, but is fixed to the housing 22 not to rotate around the central axis of the multi-core fiber 10. Since the multi-core fiber 10 is fixed to be integrated with the ferrule 21, the multi-core fiber 10 is also movable along the central axis of the multi-core fiber 10 but is not rotated around the central axis of the multi-core fiber 10.

As described above, in one or more embodiments, first, the multi-core fiber 10, in which the central core 11 and the spiral outer peripheral core 12 are formed, is inserted into the ferrule 21, and then fixed to the ferrule 21 after the multi-core fiber 10 is aligned. Next, the ferrule 21 is inserted into the housing 22 to align the position of the outer peripheral core 12 around the central axis of the multi-core fiber 10. Subsequently, in a state the housing 22 is rotated by the rotational offset amount 6 around the central axis of the multi-core fiber 10, the ferrule 21 is obliquely polished such that the width 1 of the reference surface PL0 of the ferrule 21 is the predefined width. Then, after the position of the outer peripheral core 12 is aligned, the ferrule 21 (multi-core fiber 10) is fixed to the housing 22. As a result, since the polished amount can be accurately grasped and variations when the ferrule 21 is obliquely polished can be suppressed, the connection loss can be reduced over the related art.

Further, in one or more embodiments, the ferrule 21 is obliquely polished in a state where the housing 22 is rotated around the central axis of the multi-core fiber 10 by the rotational offset amount gyp, and after the oblique polishing, the position of the outer peripheral core 12 is aligned. Therefore, the position of the outer peripheral core 12 with respect to the key 22a and the angle of the inclined surface PL1 with respect to the key 22a can be aligned.

### Fifth Example

### <Optical Connector>

As in the second example, an optical connector 5 according to one or more embodiments is configured in the same manner as the optical connector 1 shown in FIG. 1, except for the inclination direction D1 of the inclined surface PL1 of the ferrule 21. Therefore, a detailed description of the optical connector 5 will be omitted.

### <Manufacturing Method for Optical Connector>

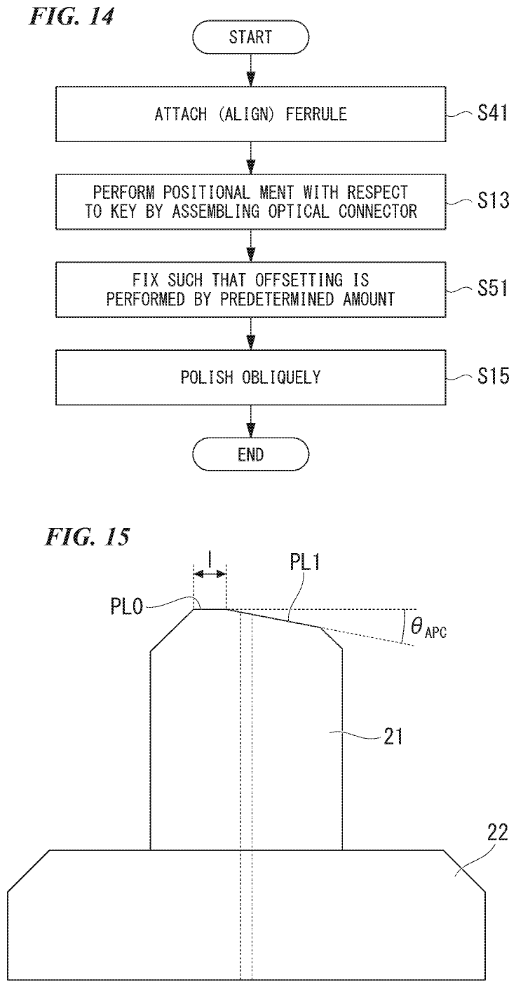

FIG. 14 is a flowchart showing a manufacturing method for an optical connector according to a fifth example. In FIG. 14, the same reference numerals are given to the same steps as those shown in FIGS. 3 and 13. In the flowchart shown in FIG. 14, step S42 in the flowchart shown in FIG. 13 is replaced with step S51, step S21 is replaced with step S15 shown in FIG. 3, and step S43 is omitted.

In one or more embodiments, first, as in the fourth example, a step of aligning the multi-core fiber 10 by attaching the multi-core fiber 10, which has a polished end surface, to the ferrule 21 such that the end surface of the multi-core fiber 10 is flush with the end surface of the ferrule 21, is performed (step S41: first step). When aligning of the multi-core fiber 10 with respect to the ferrule 21 is finished, a step of fixing the ferrule 21 to the end portion of the multi-core fiber 10 is performed using an adhesive or the like.

Next, as in the first example, a step of aligning positions of the outer peripheral cores 12a to 12c with respect to the key 22a by assembling the optical connector 5 is performed (step S13). Subsequently, in one or more embodiments, as in the third example, a step of fixing the ferrule 21 (multi-core fiber 10) to the housing 22 by setting the positions of the outer peripheral cores 12a to 12c on the end surface of the multi-core fiber 10 to offset by a predetermined amount, is performed (step S51).

Specifically, as shown in FIG. 12A, a step of rotating the outer peripheral cores 12a to 12c of the multi-core fiber 10 around the central axis of the multi-core fiber 10 by a rotational offset amount φ, is performed. However, one or more embodiments is different from the third example in that the positions of the outer peripheral cores 12a to 12c are not offset by aligning, and the positions of the outer peripheral cores 12a to 12c are offset due to rotation by a predefined rotational offset amount cp. The rotational offset amount φ is expressed by Equation (1) described above.

The ferrule 21 is movable in a direction of the central axis of the multi-core fiber 10, but is fixed to the housing 22 not to rotate around the central axis of the multi-core fiber 10. Since the multi-core fiber 10 is fixed to be integrated with the ferrule 21, the multi-core fiber 10 is also movable along the central axis of the multi-core fiber 10, but is not rotated around the central axis of the multi-core fiber 10.

Finally, a step of obliquely polishing the end surface of the ferrule 21 is performed (step S15). Specifically, as in the first example, the optical connector 5 is attached to the jig Z such that the central axis of the multi-core fiber 10 is inclined (see FIG. 6). Then, a step of polishing the end surface of the ferrule 21 (multi-core fiber 10) by bringing the ferrule 21 (multi-core fiber 10) into contact with the polishing surface of the polishing device PD, is performed. The optical connector 5 is manufactured by the above steps.

When the ferrule 21 is obliquely polished, the positional misalignment (rotational offset amount φ) of the outer peripheral cores 12a to 12c with respect to the key 22a is eliminated as shown in FIG. 12B, so that no positional misalignment occurs with respect to the key 22a. In addition, the inclination direction D1 of the inclined surface PL1 is perpendicular to the straight line L0 passing through the central core 11 and the key 22a. That is, in the optical connector 5 manufactured in one or more embodiments, as in the optical connector 3 manufactured in the third example, no positional misalignment of the outer peripheral cores 12a to 12c occurs with respect to the key 22a, and the angle of the inclined surface PL1 with respect to the key 22a is aligned.

As described above, in one or more embodiments, first, the multi-core fiber 10, in which the central core 11 and the spiral outer peripheral core 12 are formed, is inserted into the ferrule 21, and then fixed to the ferrule 21 after the multi-core fiber 10 is aligned. Next, the ferrule 21 is inserted into the housing 22 to perform positional alignment of the outer peripheral core 12 at a position having the rotational offset amount φ that can eliminate the positional misalignment of the outer peripheral core 12, which occurs due to oblique polishing, thereby fixing the ferrule 21 to the housing 22. Then, the ferrule 21 is obliquely polished such that the width 1 of the reference surface PL0 of the ferrule 21 is the predefined width. As a result, since the polished amount can be accurately grasped and variations when the ferrule 21 is obliquely polished can be suppressed, the connection loss can be reduced over the related art.

Further, in one or more embodiments, the ferrule 21 is obliquely polished in a state where the positional alignment of the outer peripheral core 12 is performed at a position having the rotational offset amount φ that can eliminate the positional misalignment of the outer peripheral core 12, which occurs due to oblique polishing. Therefore, the position of the outer peripheral core 12 with respect to the key 22a and the angle of the inclined surface PL1 with respect to the key 22a can be aligned.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims. For example, although the optical connectors 1 to 4 in the above-described embodiments are so-called straight-type connectors, the optical connector may be a so-called conical-type connector in which the tip portion of the ferrule 21 has a conical shape.

FIG. 15 is an enlarged view showing a tip portion of a ferrule included in a so-called conical-type optical connector. In the so-called conical-type optical connector, the tip portion of the ferrule 21 has a conical shape, and the end surface of the ferrule 21 is flat. As shown in FIG. 15, when the flat end surface is defined as a reference surface PL0, and the ferrule 21 is obliquely polished such that the width 1 of the reference surface PL0 is the predefined width, as in the above-described embodiments, the optical connector can be manufactured with reduced connection loss over the related art.

Further, step S16 in the first and second examples may be replaced with step S43 in the fourth example. That is, in step S16, the ferrule 21 is fixed to the housing 22 after rotating the ferrule 21 around the central axis of the multi-core fiber 10 by a certain angle. However, as in step S43, the ferrule 21 may be fixed to the housing 22 after the positions of the outer peripheral cores 12a to 12c are aligned on the end surface of the multi-core fiber 10. In addition, step S43 in the fourth example may be replaced with step S16 in the first and second examples.

Further, although the multi-core fiber 10 described in the above-described embodiments includes a linear central core 11 and three spiral outer peripheral cores 12a to 12c, the multi-core fiber can have at least one of the plurality of cores, which is spirally formed. Further, in the multi-core fiber, the central core 11 may be omitted.

Further, when FBG is formed in the central core 11 and the outer peripheral cores 12a to 12c of the multi-core fiber 10, the FBG may be formed over the entire length of the multi-core fiber 10 in the longitudinal direction or may be formed on only a partial region of the multi-core fiber 10 in the longitudinal direction. In addition, the FBG, which is formed in the central core 11 and the outer peripheral cores 12a to 12c of the multi-core fiber 10, may be FBG having a certain period or may be FBG (chirped grating) having a continuously changing period.

### REFERENCE SIGNS LIST

1 to 4: Optical connector
10: Multi-core fiber
12: Outer peripheral core
21: Ferrule
22: Housing
PL0: Reference surface

1. A manufacturing method for an optical connector, comprising:
inserting and fixing a multi-core fiber into a ferrule, wherein at least one of a plurality of cores of the multi-core fiber is a spiral core;
inserting the ferrule into a housing and aligning the cores with the housing around a central axis of the multi-core fiber; and
obliquely polishing the ferrule until a width of an end surface of the ferrule perpendicular to a direction of the central axis reaches a predefined width.

2. The manufacturing method according to claim 1, further comprising:
after inserting and fixing the multi-core fiber but before inserting the ferrule and aligning the cores, forming the end surface of the ferrule by polishing the ferrule perpendicularly to the direction of the central axis.

3. The manufacturing method according to claim 1, wherein the aligning of the cores includes aligning the cores at a position having a rotational offset amount that compensates for expected positional misalignment of the cores due to the oblique polishing of the ferrule.

4. The manufacturing method according to claim 1, wherein the oblique polishing of the ferrule includes obliquely polishing the ferrule while the housing rotates around the central axis to have a rotational offset amount that compensates for expected positional misalignment of the cores due to the oblique polishing of the ferrule.

5. The manufacturing method according to claim 2, further comprising:
after the oblique polishing of the ferrule, fixing the ferrule to the housing by rotating the ferrule around the central axis.

6. The manufacturing method according to claim 2, further comprising:
after the oblique polishing of the ferrule, fixing the ferrule to the housing by aligning positions of the cores.

7. The manufacturing method according to claim 3, wherein the rotational offset amount is expressed by
$$φ = \frac{2 π}{fw} \times ( \frac{d}{2} - l ) \times tan {θ}_{APC}$$
where
φ is the rotational offset amount,
fw is a spiral period of the multi-core fiber,
d is a diameter of the end surface of the ferrule before obliquely polishing the ferrule,
l is the width of the end surface of the ferrule, and
θ_{APC} is an angle at which the ferrule is obliquely polished.

8. The manufacturing method according to claim 1, wherein the fixing of the multi-core fiber includes fixing the multi-core fiber to the ferrule such that, in a state where positions of the cores around the central axis having a polished end surface are aligned with respect to the ferrule, the polished end surface is flush with the end surface of the ferrule.
